(19) United States
(12) Patent Application Publication
(10) Pub. No.: US 2016/0196318 A1
(43) Pub. Date: Jul. 7, 2016

(54) RECONSTITUTION ORDER OF ENTITY EVALUATIONS

(71) Applicant: INTERNATIONAL BUSINESS MACHINES CORPORATION, Armonk, NY (US)

(72) Inventors: Jeffrey J. Jonas, Las Vegas, NV (US); Brian E. Macy, Henderson, NV (US); William M. Milligan, San Diego, CA (US)

(21) Appl. No.: 14/590,165

(22) Filed: Jan. 6, 2015

(51) Int. Cl. G06F 17/30

(52) U.S. Cl. CPC G06F 17/30569; G06F 17/30424

(57) ABSTRACT

Methods and apparatus, including computer program products, implementing and using techniques for evaluating an original resolved entity in an entity resolution engine. A resolved entity is selected. The resolved entity includes two or more observed entities. It is attempted to separate the selected resolved entity into two or more virtual resolved entities based on a number of like features. In response to detecting that more than one virtual entity remains after decomposing the selected resolved entity, an entity resolution process is iteratively performed on each remaining virtual resolved entity until no further entity resolution events are triggered, and in response to detecting that two or more virtual resolved entities remain after the entity resolution process, the resolved entity is unresolved.

### BACKGROUND

The present invention relates to entity analytics, and more specifically, to evaluating the composition of a logical entity.

Entity analytics engines typically integrate diverse observations (data) as it arrives, in real-time. The various observations are then combined into entities by the entity analytics engine, much like a person would try to decide if a collection of puzzle pieces belongs to the same puzzle or to multiple puzzles. The more puzzle pieces that are integrated into the puzzle, the more complete the picture (i.e., the entity) becomes. A resolved entity is made up of a set of observed entities and their associated feature mappings.

Some entity analytics engines contain an “Unresolve” mechanism, that is, functionality for evaluating the composition of a resolved entity. The evaluation determines whether the current composition of an entity is correct, as defined by the current data and system configuration, or if some subset of the entity should be broken out, that is, “un-resolved,” into one or more separate resolved entities. The smallest level of granularity that can be split out of the original resolved entity is a single observed entity. If the result of the Unresolve evaluation is that the entity should not remain whole, updates are made to an entity analytics repository that contains information about the resolved entities to correct the composition of the entities.

Expressed differently, the Unresolve mechanism allows the entity analytics engine to “change its mind” and correct previous resolution results based on the most current data and system configuration. Typically the complexity for the Unresolved evaluation is O(n²).

The scale of how much analysis must be done in a typical Unresolve implementation quickly becomes massive and unacceptable. For example, if entity being evaluated contains 100,000 accounts, it might require as many as 5 billion entity resolution evaluations to complete. The volume of processing required and time it takes to complete the evaluations in the Unresolve operation determine whether the Unresolve operation is worth doing. In situations where, say money transfers or law enforcement actions, depend on the results of the Unresolve operation, it may often be unacceptable to wait for hours or days (or longer) for the processing to complete. Thus, there is a need for improved Unresolve techniques in evaluating the composition of a logical entity.

### SUMMARY

According to one embodiment of the present invention, techniques for evaluating an original resolved entity in an entity resolution engine are described. A resolved entity is selected. The resolved entity includes two or more observed entities. It is attempted to separate the selected resolved entity into two or more virtual resolved entities based on a number of like features. In response to detecting that more than one virtual entity remains after decomposing the selected resolved entity, an entity resolution process is iteratively performed on each remaining virtual resolved entity until no further entity resolution events are triggered, and in response to detecting that two or more virtual resolved entities remain after the entity resolution process, the resolved entity is unresolved.

One significant advantage with the various embodiments of the Unresolve process as claimed and existing Unresolve process, is how the Unresolve processes in accordance with the invention evaluate the component accounts in a specific order to reduce the number of evaluations required to attempt to reconstruct the logical entity. The benefits of this Unresolve process include, for example, reduced scale with a reasonably accurate outcome of entity evaluations

The details of one or more embodiments of the invention are set forth in the accompanying drawings and the description below. Other features and advantages of the invention will be apparent from the description and drawings, and from the claims.

### BRIEF DESCRIPTION OF THE SEVERAL VIEWS OF THE DRAWINGS

FIG. 1 shows an Unresolve process (100), in accordance with one embodiment.

FIG. 2 shows a schematic illustration of the original content (200) in an entity resolution repository (200) prior to an Unresolved operation being performed in accordance with one embodiment.

FIG. 3 shows a virtual repository containing a set of virtual resolved entities (300) in accordance with one embodiment.

FIG. 4 shows a set of virtual resolved entities (400) in accordance with one embodiment.

FIG. 5 shows the entity resolution repository (200) after completion of the Unresolve operation.

Like reference symbols in the various drawings indicate like elements.

### DETAILED DESCRIPTION

### Overview

The various embodiments of the invention relate to techniques for an entity analytics engine to evaluate the composition of a resolved entity. For simplicity, this will be referred to as an “Unresolve process” or “Unresolve functionality” in this document. The Unresolve process checks, in light of new data for the entity, what is the correct composition of the logical entity, based on a current configuration of the entity resolution system. The result of the evaluation provides an answer to the question “Is the composition of the resolved entity correct?” If the resulting answer is “no”, previous assertions can be overturned and corrected based on the new data. That is, the Unresolve process provides methods allowing the entity analytics engine to “change its mind” and split up the original resolved entity to reflect the set of resolved entities the Unresolve process believes is correct, based on currently available information.

One distinction between the various embodiments of the Unresolve process described herein and existing Unresolve process, is how the Unresolve processes in accordance with the invention evaluate the component accounts in a specific order to reduce the number of evaluations required to attempt to reconstruct the logical entity. The benefits of this Unresolve process include, for example, reduced scale with a reasonably accurate outcome of entity evaluations.

Some terms that are used in this description include: “resolved entity,” which is a logical entity composed of a number of “observed entities” (sometimes also referred to as “accounts”). The observed entity is a representation of one or more collections of data describing an entity (often a person or organization). Each observed entity also contains “features,” which is an umbrella term describing detailed data that helps describe the observed entity. Examples of features include a social security number, name, address, phone number, gender, etc.

The resolved entity is effectively a logical aggregate of a set of observed entities. No observed entity is shared between more than one resolved entity in the entity analytics system. Once the Unresolve process has initially split a resolved entity into a set of individual observed entities, the Unresolve process will assign a unique identifier to each observed entity and treat each observed entity as a virtual resolved entity in its own right.

Each observed entity also has a dynamically generated feature that is referred to as a “Grouper Key.” The Grouper Key serves as a checksum for the observed entity, providing a single feature value (e.g., a checksum) that represents features for an observed entity that are significant to entity resolution. The Grouper Key is used to merge all other observed entities (“virtual resolved entities” after an initial Unresolve step) with identical Grouper Key values. This initial merge step has the potential to reduce the number of evaluations needed in large entities. In one embodiment, the Grouper Key also contains two special attributes that are used by the Unresolve evaluation process: an Exclusivity score and a Richness score. The Exclusivity score is a measure of how uniquely-identifying the full set of features of an observed entity are (i.e., an observed entity with a social security number, a tax ID number, driver's license number, etc.). The “Richness Score” is a measure of how many features are provided for an observed entity (i.e., a metric for quantity). Each virtual resolved entity maintains a running sum of all exclusivity scores, as well as richness scores, for each Grouper Key (only one per observed entity) held by the observed entities by which it is composed. As will be seen below, these running sums are used to determine the entity sort order.

The Unresolve process identifies which observed entities hold a conflicting exclusive feature. Each feature also carries with it a set of different attributes. One of these attributes is whether a particular type of feature (e.g., social security number, date of birth, gender, etc.) is flagged as being exclusive. Conflicting exclusive values are frequently at the heart of deciding whether two entities being evaluated should be considered to be one and the same be merged into the same logical entity. For this important processing, the Unresolve process in accordance with one embodiment identifies each virtual entity under evaluation and seeks to test each one for entity resolution before evaluating non-conflicting virtual entities. Additionally, when the Unresolve process attempts to reconstruct the original resolved entity, it is preferable to evaluate conflicting data first, since these conflicts may cause earlier entity resolutions to be overturned.

In addition to providing methods for evaluating a resolved entity, reducing the scale of the evaluation work compared to existing Unresolve methods is also important. While there are existing Unresolve methods that guarantee independence of resolution-order, the tradeoff is their larger scale, typically with O(n²) complexity). The various implementations of Unresolve methods described herein, however, leverages the Grouper Key functionality and define an entity evaluation order to provide a O(n) complexity (or even smaller) for the number of entity evaluations required, especially where Grouper Key matches can reduce entity resolutions below n. As a worst-case scenario, the Unresolve methods described herein will do as many resolution evaluations as there are observed entities in the resolved entity being evaluated.

Another important aspect relates to when to trigger an Unresolve evaluation. Preferably, only scenarios that have a possibility of causing the entity analytics engine to correct previous entity resolutions, should trigger an Unresolve evaluation. Some examples of events that could trigger the Unresolve process include the deletion of an observed entity when the entity started with three or more observed entities, the addition of new scored features to an existing entity, scored or candidate-builder features occurring in resolved entities with sufficient frequency to be treated as “generic” (i.e., neither used for candidate building nor for scoring). It should be noted that these are merely a few examples of possible trigger events, and many other trigger events that fall within the scope of the claims can be envisioned by those having ordinary skill in the art. Next, an Unresolve process will be described by way of example and with reference to the figures.

### Exemplary Unresolve Process

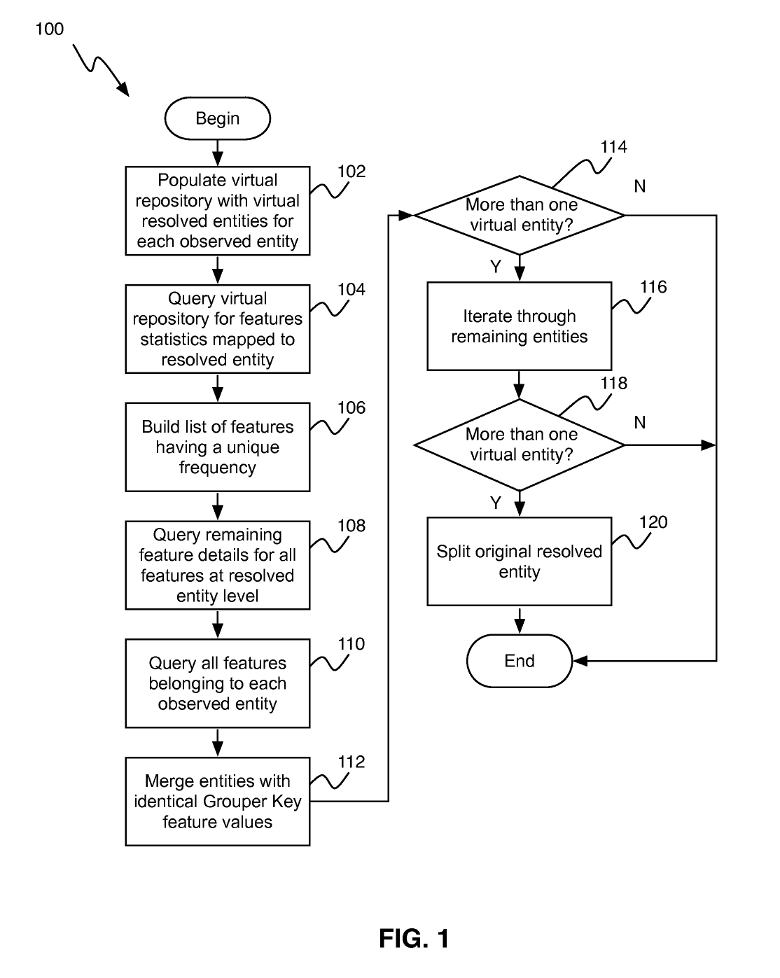

An exemplary Unresolve process (100) will now be described with reference to FIGS. 1-5. In the illustrated embodiment, the Unresolve process (100) takes place isolated from the full entity analytics repository in which the resolved entities are stored. One can consider the Unresolve process (100) taking place in a separate “virtual repository” that only contains the observed entities and features that belong to the resolved entity under evaluation, as will be described in further detail below. In order to simplify the explanation herein, this example will focus on the evaluation of a single resolved entity to be evaluated. Furthermore, the resolved entity being evaluated is the one belonging to an inbound Universal Message Format (UMF) record being processed. It should, however, be understood that in other embodiments, multiple resolved entities can be evaluated using similar techniques to those described herein.

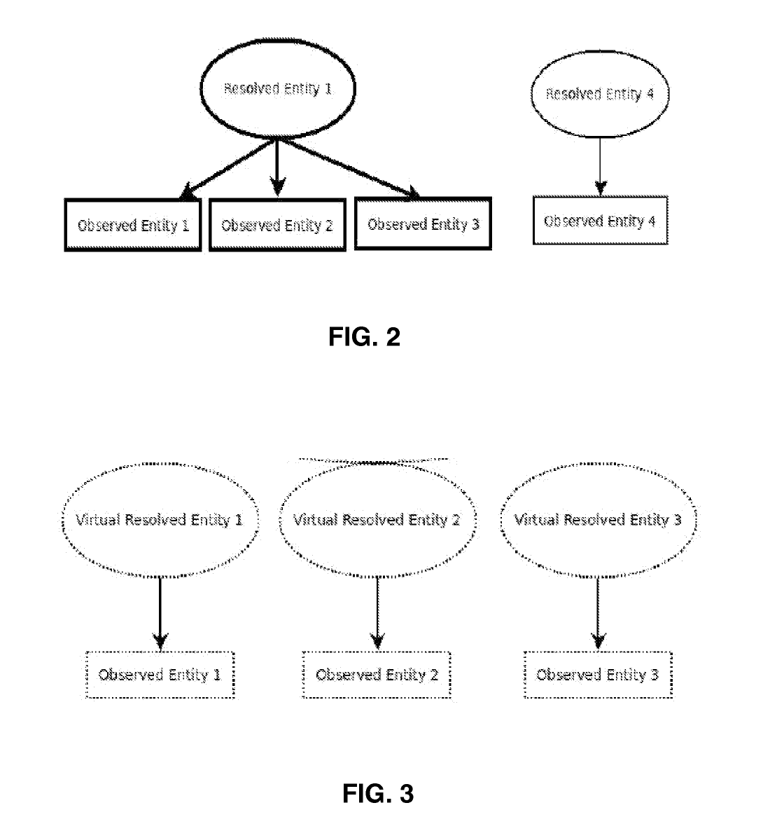

FIG. 2 shows a schematic view of a repository that contains a Resolved Entity 1 and a Resolved Entity 4. Resolved Entity 1 is in its current form composed of Observed Entity 1, Observed Entity 2 and Observed Entity 3. Resolved Entity 4 is composed of Observed Entity 4. FIG. 1 shows how an Unresolved process (100) is applied to Resolved Entity 1 in order to determine whether the composition of Resolved Entity 1 (i.e., Observed Entity 1, Observed Entity 2, and Observed Entity 3) is correct or need to be changed. Typically, both observed entities and resolved entities are stored to persistent storage (e.g., a database, etc.).

As shown in FIG. 1, the process (100) starts by populating the empty virtual repository with one “virtual resolved entity” for each observed entity (step 102). A schematic view of such a populated virtual repository is shown in FIG. 3. Typically, the virtual resolved entities only exist in memory (RAM) and are not written to persistent storage. In one embodiment, the resolved entity ID value is always equal to the lowest value observed entity ID it holds. This logic is used to assign a virtual resolved entity ID equal to the observed entity ID since initially, each virtual entity only holds a single observed entity. Features belonging to each observed entity are also mapped to the newly created virtual resolved entities. This step effectively splits the original entity into its individual component entities.

Next the repository is queried for all feature statistics for the features mapped to the original resolved entity (step 104). As will be described below, these feature statistics are later used to determine whether any feature values are to be treated as generic and either skipped from use in candidate list building or feature scoring.

Next, a list is built of features that have a unique frequency (step 106). This list will be used to later check whether any unique features are in conflict. This is part of a virtual resolved entity sort criteria used in a later step.

Next, the remaining feature details, such as feature element values, from and thru dates, etc., are queried for all features at the resolved entity level (step 108). This provides the aggregate feature details for the original resolved entity being evaluated.

Next, all features belonging to each observed entity are queried (step 110). Initially, the query results are used to map features to the initial set of virtual resolved entities. This step provides more granular detail than the aggregate feature details in step 108, as well as support for virtual entity resolution evaluation in later steps.

Next, all virtual entities that have identical Grouper Key feature values are merged (step 112), as this indicates that the virtual entities are duplicates of each other. When the virtual entities are merged, the virtual entity with the higher entity ID value is merged into the lower entity ID one. Also, each virtual resolved entity keeps track of separate sums of exclusivity and richness scores, parsed from each (single) Grouper Key feature per observed entity. These two sum values are used in a later step.

Next, the process checks to see how many virtual entities remain in the virtual repository (step 114). If only a single virtual entity remains, the Unresolve evaluation is complete and the process (100) ends. That is, the single resolved entity that was under evaluation is in a correct state and a log entry is made that an Unresolve evaluation was completed and there was no action to take.

If it is determined in step 114 that more than one virtual entity remains in the virtual repository, the process iterates through these remaining entities (step 116), using the following sort order: entities holding one of the conflicting exclusive features, descending exclusivity sum, and descending richness sum. Any ties are broken by using the lowest feature ID value for a held Grouper Key. Feature ID values are typically assigned in increasing order over time, so the lowest feature ID value implies the first of the Grouper Key features written to the database. Since entities with matching Grouper Key feature values were matched in step 112, it is guaranteed that all remaining virtual entities have distinct Grouper Key values. This provides a deterministic sort order. With each iteration, a virtual entity resolution process (including checking for generics, candidate list building, feature scoring, summary generation, entity resolution rule evaluation and resolution determination) is run. Virtual entities that are found to resolve are merged into the entity with the lower entity ID.

Next, the process checks again how many virtual entities remain in the repository (step 118). Again, if only a single entity remains, the evaluation has determined that the entity is already in the correct resolved state, a log entry is generated and the process ends.

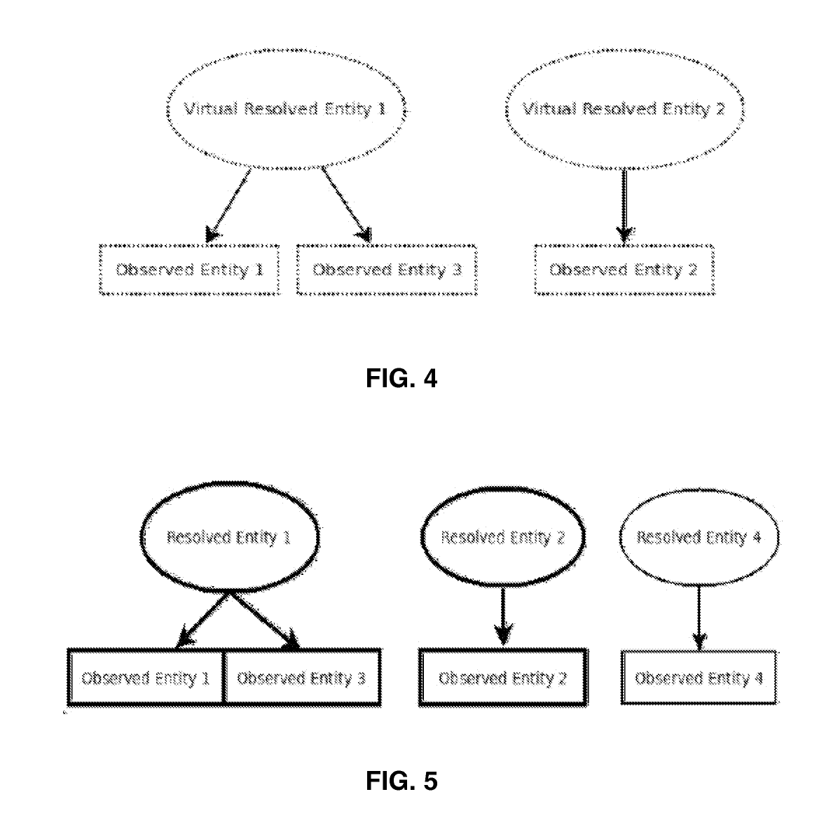

If it is determined in step 118 that several virtual entities remain in the repository, as is the case illustrated in FIG. 4, updates to the actual entity analytics repository are carried out in order to move a portion of the observed entities out of the original resolved entity into the destination resolved entities identified by the evaluation. Details of any split-up entities are also logged. This ends the process (100). FIG. 5 shows the resulting entity analytics repository after the Unresolved process (100). As can be seen in FIG. 5, Resolved Entity 1 has been corrected to be composed by Observed Entity 1 and Observed Entity 3, and a new Resolved Entity 2 has been created, which is composed by Observed Entity 2. Resolved Entity 4 has not been involved in the process (100) and remains in its original form in the repository.

In one embodiment, if the original resolved entity is split up, each of the resulting resolved entities (including the original one being evaluated) will subsequently undergo a re-resolve process. The re-resolve evaluations are required since the Unresolve process was completed in isolation from the rest of the entity analytics entity repository. Each of the resulting split-up entities will have a set of observed entities and features that are different from the original evaluated entity, and must therefore check if any of the entities and features can now merge with any other resolved entities in the repository. Once all the re-resolve evaluations have been completed, the entity analytics repository is considered to be in a correct state.

### Performance Considerations

Unresolve evaluations always impose a cost in CPU cycles, memory and time. As the skilled person realizes, the fastest Unresolve evaluation is when it is determined that no Unresolve evaluation is needed. In one embodiment, when Unresolve evaluations are triggered, the evaluation uses previously generated Grouper Key features in an attempt to reduce the number of resolutions to complete the evaluation. The worst-case for Unresolve evaluation scale is when no Grouper Key matches exist in the resolved entity being evaluated.

Other factors for how Unresolve evaluations perform is the number of observed entities composing the evaluated resolved entity, the volume and types of features being used for candidate list building and feature-scoring, the efficiency of resolutions, how many entity resolution fragments and entity resolution rule Xpath expressions are configured and into how many entities an entity may be required to be split up.

### Alternative Embodiments

The above exemplary embodiment is merely one embodiment showing how an Unresolve process and a corresponding system can function. As the skilled person realizes, many alternative embodiments and features can be implemented. Below are some examples of features that may be included in some embodiments.

The choice of tie-breaking criteria explained above, that is, the Grouper Key value, for defining a virtual entity sort-order is merely one way in which the sort-order can be defined. It also implies a temporal attribute. Other ways of defining virtual entity sort orders can be used, as envisioned by those of ordinary skill in the art. For example, “max feature ID value” tiebreaker criteria can be used, which would imply a “most current” feature. This would provide a tiebreaker weighted more heavily on the most up-to-date feature information to be considered first for entity resolution evaluations. This type of design decision puts emphasis on whatever details you think are most significant.

In some embodiments, the Unresolve evaluation can log entity-reconstitution detail logging when the Unresolve evaluation results in splitting up the original entity. In some embodiments, logging can be added to differentiate when an action was taken or no action occurred. Thereby, it is possible to track which entity resolution process was being executed as part of an entity resolution transaction. In some embodiments, triggered re-resolve evaluations on split-up entities can use an entity resolution transaction identifier.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1-7. (canceled)

8. A computer program product for evaluating an original resolved entity in an entity resolution engine, the computer program product comprising a computer readable storage medium having program instructions embodied therewith, wherein the computer readable storage medium is not a transitory signal per se, the program instructions being executable by a processor in an entity resolution engine to cause the processor to perform a method comprising:
selecting a resolved entity, the resolved entity comprising two or more observed entities;
attempting to separate the selected resolved entity into two or more virtual resolved entities based on a number of like features;
in response to detecting that more than one virtual entity remains after decomposing the selected resolved entity:
iteratively performing an entity resolution process on each remaining virtual resolved entity until no further entity resolution events are triggered; and
in response to detecting that two or more virtual resolved entities remain after the entity resolution process, unresolving the resolved entity.

9. The computer program product of claim 8, wherein separating the resolved entity is based on one or more of: physical separation, logical separation, and temporal separation.

10. The computer program product of claim 8, wherein unresolving the resolved entity is done based on the separating of the selected resolved entity into virtual resolved entities and on results from the entity resolution process.

11. The computer program product of claim 8, wherein the like features include a single value that represents a plurality of features associated with an observed entity.

12. The computer program product of claim 8, wherein the method further comprises:
re-resolving any newly created entities created as a result of unresolving the resolved entity.

13. The computer program product of claim 8, wherein the entity resolution process is performed in a prescribed order.

14. The computer program product of claim 13, wherein the prescribed order includes one of: a feature richness and a feature exclusivity contained in the observed entity.

15. An entity resolution engine for evaluating an original resolved comprising:
a processor; and
a memory, wherein the memory contains instructions that when executed by the processor causes the following method to be performed:
selecting a resolved entity, the resolved entity comprising two or more observed entities;
attempting to separate the selected resolved entity into two or more virtual resolved entities based on a number of like features;
in response to detecting that more than one virtual entity remains after decomposing the selected resolved entity:
iteratively performing an entity resolution process on each remaining virtual resolved entity until no further entity resolution events are triggered; and
in response to detecting that two or more virtual resolved entities remain after the entity resolution process, unresolving the resolved entity.
